(19) United States
(12) Patent Application Publication
(10) Pub. No.: US 2026/0333178 A1
(43) Pub. Date: Oct. 22, 2026

(54) PRECONFIGURED CHO

(71) Applicant: Nokia Technologies Oy, Espoo (FI)

(72) Inventors: Dimitri GOLD, Espoo (FI); Lars DALSGAARD, Oulu (FI)

(21) Appl. No.: 19/110,321

(22) PCT Filed: Sep. 20, 2022
(86) PCT No.: PCT/US2022/044149

§ 371 Date: Mar. 10, 2025

(51) Int. Cl. H04W 36/36

(52) U.S. Cl. CPC H04W 36/362

(57) ABSTRACT

Systems, methods, apparatuses, and computer program products for mobility setting preconfiguration, activation, and execution for conditional handover. One method may include transmitting, to a user equipment, a control message comprising at least one preconfigured conditional handover; detecting at least one setting associated with activation of at least one of the preconfigured conditional handovers; and transmitting, to the user equipment, in response to the detection, an indication configured to activate conditional handover according to at least one of the preconfigured conditional handovers.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for mobility setting preconfiguration, activation, and execution for conditional handover.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include transmitting, to a user equipment, a control message comprising at least one preconfigured conditional handover. The method may further include detecting at least one setting associated with activation of at least one of the preconfigured conditional handovers. The method may further include transmitting, to the user equipment, in response to the detection, an indication configured to activate conditional handover according to at least one of the preconfigured conditional handovers.

In accordance with certain example embodiments, an apparatus may include means for transmitting, to a user equipment, a control message comprising at least one preconfigured conditional handover. The apparatus may further include means for detecting at least one setting associated with activation of at least one of the preconfigured conditional handovers. The apparatus may further include means for transmitting, to the user equipment, in response to the detection, an indication configured to activate conditional handover according to at least one of the preconfigured conditional handovers.

In accordance with various example embodiments, a non-transitory computer readable medium may include program instructions that, when executed by an apparatus, cause the apparatus to perform at least a method. The method may include transmitting, to a user equipment, a control message comprising at least one preconfigured conditional handover. The method may further include detecting at least one setting associated with activation of at least one of the preconfigured conditional handovers. The method may further include transmitting, to the user equipment, in response to the detection, an indication configured to activate conditional handover according to at least one of the preconfigured conditional handovers.

In accordance with some example embodiments, a computer program product may perform a method. The method may include transmitting, to a user equipment, a control message comprising at least one preconfigured conditional handover. The method may further include detecting at least one setting associated with activation of at least one of the preconfigured conditional handovers. The method may further include transmitting, to the user equipment, in response to the detection, an indication configured to activate conditional handover according to at least one of the preconfigured conditional handovers.

In accordance with certain example embodiments, an apparatus may include at least one processor and at least one memory storing instructions that, when executed by the at least one processor, cause the apparatus at least to transmit, to a user equipment, a control message comprising at least one preconfigured conditional handover. The at least one memory and instructions, when executed by the at least one processor, may further cause the apparatus at least to detect at least one setting associated with activation of at least one of the preconfigured conditional handovers. The at least one memory and instructions, when executed by the at least one processor, may further cause the apparatus at least to transmit, to the user equipment, in response to the detection, an indication configured to activate conditional handover according to at least one of the preconfigured conditional handovers.

In accordance with various example embodiments, an apparatus may include transmitting circuitry configured to transmit, to a user equipment, a control message comprising at least one preconfigured conditional handover. The apparatus may further include detecting circuitry configured to detect at least one setting associated with activation of at least one of the preconfigured conditional handovers. The apparatus may further include transmitting circuitry configured to transmitting, to the user equipment, in response to the detection, an indication configured to activate conditional handover according to at least one of the preconfigured conditional handovers.

In accordance with some example embodiments, a method may include receiving, from a source network entity, a control message comprising at least one conditional handover preconfiguration. The method may further include receiving, from the source network entity, an indication configured to activate conditional handover according to the at least one conditional handover preconfiguration and at least one change triggering condition. The method may further include executing, based upon the received control message and received indication, conditional handover according to the at least one conditional handover preconfiguration.

In accordance with certain example embodiments, an apparatus may include means for receiving, from a source network entity, a control message comprising at least one conditional handover preconfiguration. The apparatus may further include means for receiving, from the source network entity, an indication configured to activate conditional handover according to the at least one conditional handover preconfiguration and at least one change triggering condition. The apparatus may further include means for executing, based upon the received control message and received indication, conditional handover according to the at least one conditional handover preconfiguration.

In accordance with various example embodiments, a non-transitory computer readable medium may include program instructions that, when executed by an apparatus, cause the apparatus to perform at least a method. The method may include receiving, from a source network entity, a control message comprising at least one conditional handover preconfiguration. The method may further include receiving, from the source network entity, an indication configured to activate conditional handover according to the at least one conditional handover preconfiguration and at least one change triggering condition. The method may further include executing, based upon the received control message and received indication, conditional handover according to the at least one conditional handover preconfiguration.

In accordance with some example embodiments, a computer program product may perform a method. The method may include receiving, from a source network entity, a control message comprising at least one conditional handover preconfiguration. The method may further include receiving, from the source network entity, an indication configured to activate conditional handover according to the at least one conditional handover preconfiguration and at least one change triggering condition. The method may further include executing, based upon the received control message and received indication, conditional handover according to the at least one conditional handover preconfiguration.

In accordance with certain example embodiments, an apparatus may include at least one processor and at least one memory storing instructions that, when executed by the at least one processor, cause the apparatus at least to receive, from a source network entity, a control message comprising at least one conditional handover preconfiguration. The at least one memory and instructions, when executed by the at least one processor, may further cause the apparatus at least to receive, from the source network entity, an indication configured to activate conditional handover according to the at least one conditional handover preconfiguration and at least one change triggering condition. The at least one memory and instructions, when executed by the at least one processor, may further cause the apparatus at least to execute, based upon the received control message and received indication, conditional handover according to the at least one conditional handover preconfiguration.

In accordance with various example embodiments, an apparatus may include receiving circuitry configured to receive, from a source network entity, a control message comprising at least one conditional handover preconfiguration. The apparatus may further include receiving circuitry configured to receive, from the source network entity, an indication configured to activate conditional handover according to the at least one conditional handover preconfiguration and at least one change triggering condition. The apparatus may further include executing circuitry configured to execute, based upon the received control message and received indication, conditional handover according to the at least one conditional handover preconfiguration.

### BRIEF DESCRIPTION OF THE DRAWINGS

For a proper understanding of example embodiments, reference should be made to the accompanying drawings, wherein:

FIG. 1 illustrates an example of a conditional handover procedure.

FIG. 2 illustrates an example downlink beam changes in a high speed train scenario.

FIG. 3 illustrates an example of reference signal received power traces of serving and target remote radio heads.

FIG. 4 illustrates mobility failure statistics from a system-level simulator.

FIG. 5 illustrates handover system-level simulations statistics comparing conservative and aggressive mobility settings for different values of discontinuous reception.

FIG. 6 illustrates an example of a flow diagram of a method according to various example embodiments.

FIG. 7 illustrates an example of a signaling diagram according to certain example embodiments.

FIG. 8A illustrates an example of reference signal received power traces of a serving and best target cell for one generic mobility setting.

FIG. 8A illustrates an example of reference signal received power traces of a serving and best target cell for two mobility settings.

FIG. 9 illustrates an example of various network devices according to some example embodiments.

FIG. 10 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for mobility setting preconfiguration, activation, and execution for conditional handover (CHO) is not intended to limit the scope of certain example embodiments, but is instead representative of selected example embodiments.

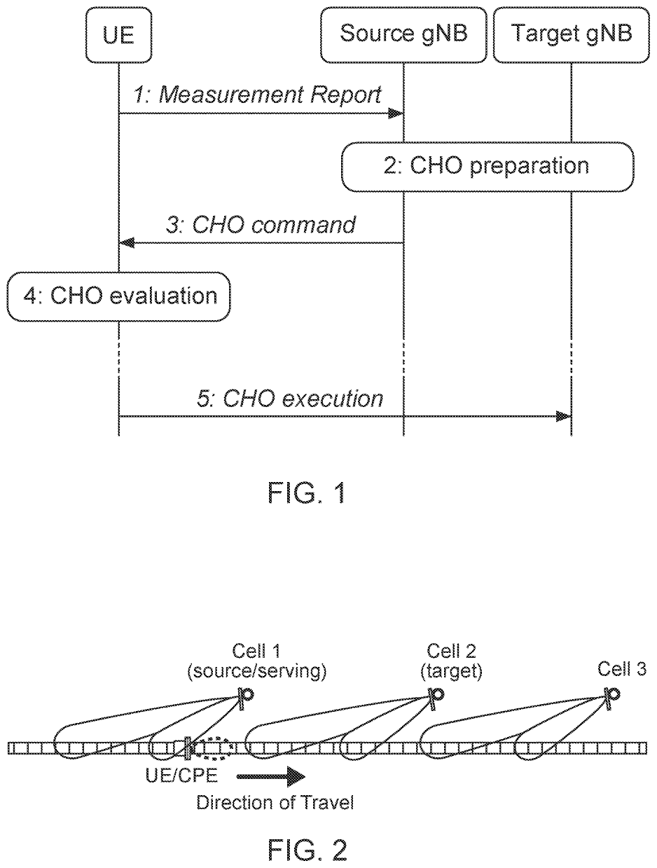

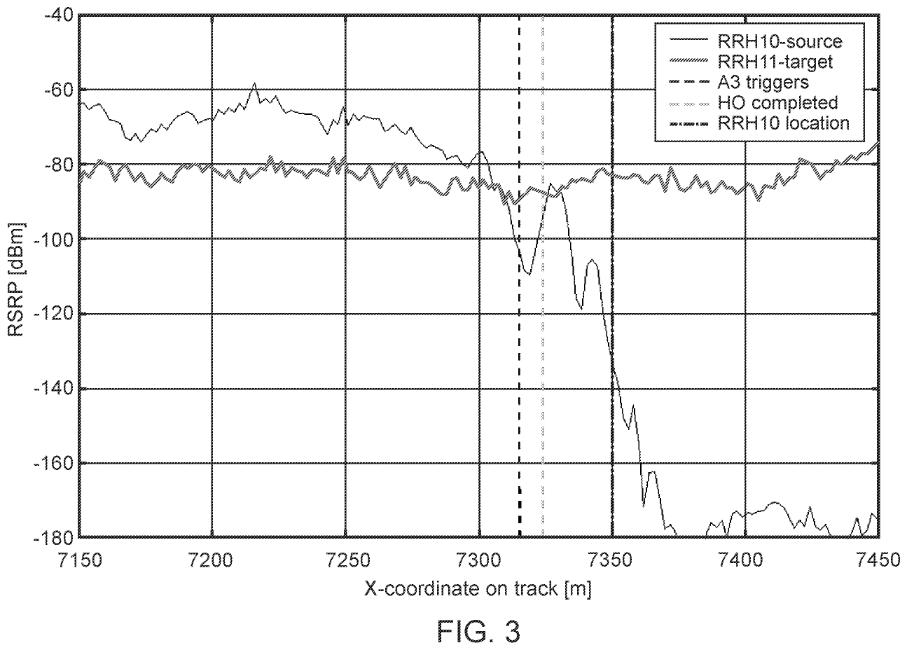

CHO may be defined as a handover (HO) that is executed by a user equipment (UE) when one or more HO execution conditions are met. As illustrated in FIG. 1, CHO can enable a network to preconfigure the UE with one or more HO candidates and conditions when the UE autonomously initiates HO towards one of the preconfigured CHO candidates. Once the UE has been configured with one or more CHO candidates, the UE may perform normal mobility measurements on the configured candidates, and possibly non-CHO candidate cells. If one of the CHO candidate cells fulfill the conditions configured for the CHO, the UE may switch to the target CHO candidate cells and initiate a random access procedure, without needing to send a measurement report and then waiting for a HO command. Using these techniques, HO can be used between cells in high speed train (HST) deployments, as shown in FIG. 2 and other scenarios. While HST deployments are used as an example in this disclosure, any type of scenario where a UE moves, including moving rapidly, between serving areas may be used (e.g., cars, motorcycles, aircraft, drones). The method may be applied in general and is not limited to specific velocities or scenarios.

3GPP Release (Rel)-17 includes requirements for the HST deployments in millimeter wave (mmWave) bands (e.g., frequency range 2 (FR2)). For example, two requirements correspond to 2 receive (Rx) beams at the UE when remote radio heads (RRH) are located next to a road or railway track (e.g., 10 meters away), and with 6 Rx beams when the RRHs at positioned at a further distance. 3 GPP Rel-18 is continuing to develop HST FR2 techniques, including deployments in tunnels where the RRHs are positioned relatively close to the track, creating challenging mobility conditions.

Some such mobility scenarios require very timely and low latency cell changes and beam switches. For example, UEs may cross the edge of a cell and beam and/or beams at very high speeds; in a high-frequency (e.g., mm Wave) deployment, the serving beam may deteriorate very rapidly when the UE approaches, for example, the cell edge.

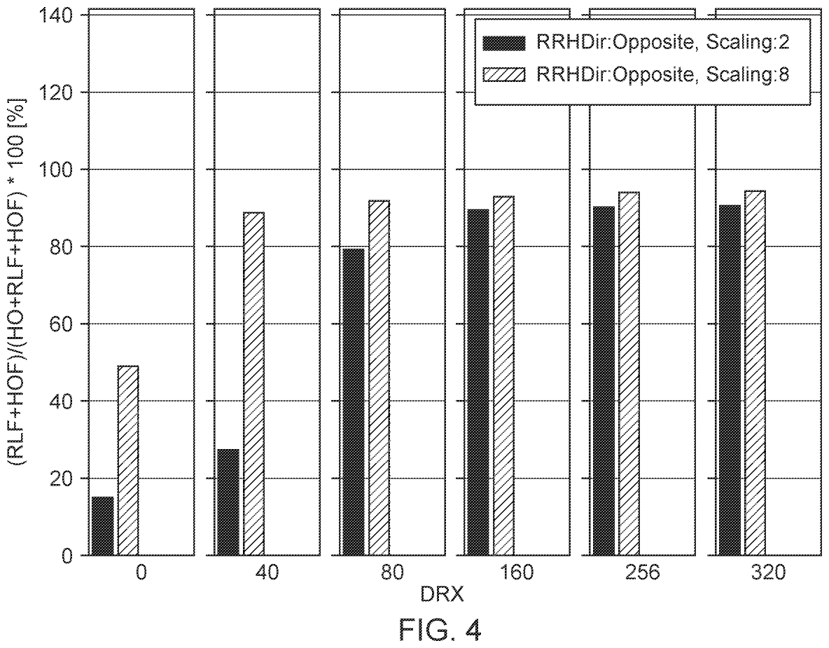

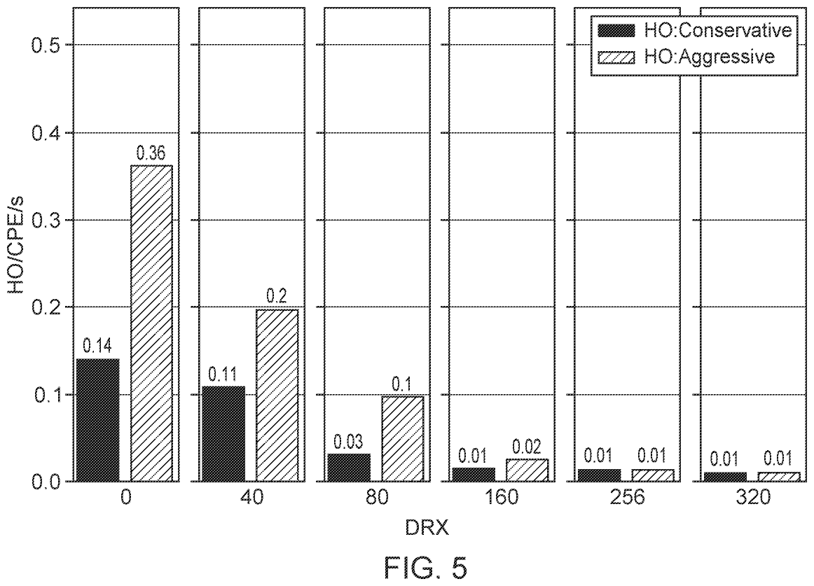

This may occur when a HST UE travels towards a transmission point (e.g., transmission reception point (TRP), RRH, access point (AP)), as depicted in FIG. 2. In this situation, the reference signal received power (RSRP) of the serving beam may drop from −80 decibel-milliwatts (dBm) to −110 dBm in less than 20 meters, as shown in FIG. 3. In particular, FIG. 3 shows RSRP traces of serving and target RRHs, with vertical lines indicating event A3 trigger coordinates (i.e., triggered when a neighboring cell becomes better than the serving cell by an offset), HO complete, and source RRH locations. This drop in RSRP may occur due to sharp beamforming used in FR2 to cover the longer inter-cell distance (700 m in HST FR2 priority scenarios). Additionally, the backplane may cancel the signal radiation behind the RRH. Therefore, if high-speed mobility relies on legacy mechanisms (e.g., layer 1 (L1)/L3 measurements averaging, feedback from the UE, mobility command signaling to/from the base station), the UE may experience very low signal to interference & noise ratio (SINR) conditions. Closed mobility loops based on measurements may also be too slow to avoid signal degradation and mobility problems from the serving beam. This is depicted in the results of mobility failure statistics from a system-level simulator shown in FIG. 4, which shows that, even with enhanced requirements (e.g., Scaling 2), mobility failures may occur without discontinuous reception (DRX) (i.e., DRX 0 in FIG. 4), e.g., in the scenario shown in FIG. 2. As shown in FIG. 2, the train may move in the direction opposite to the orientation of the RRH panels and beams.

In order to provide timely and robust beam changes, the network would need the UE to provide the network with assistance and feedback (i.e., RSRP reports, RSRQ reports, SINR reports). If the beam change involves strict timing requirements, continuous and low latency reports may be needed from the UE, which could increase UE measurement burdens, power consumption, and reporting and network UL resources consumed by the UE.

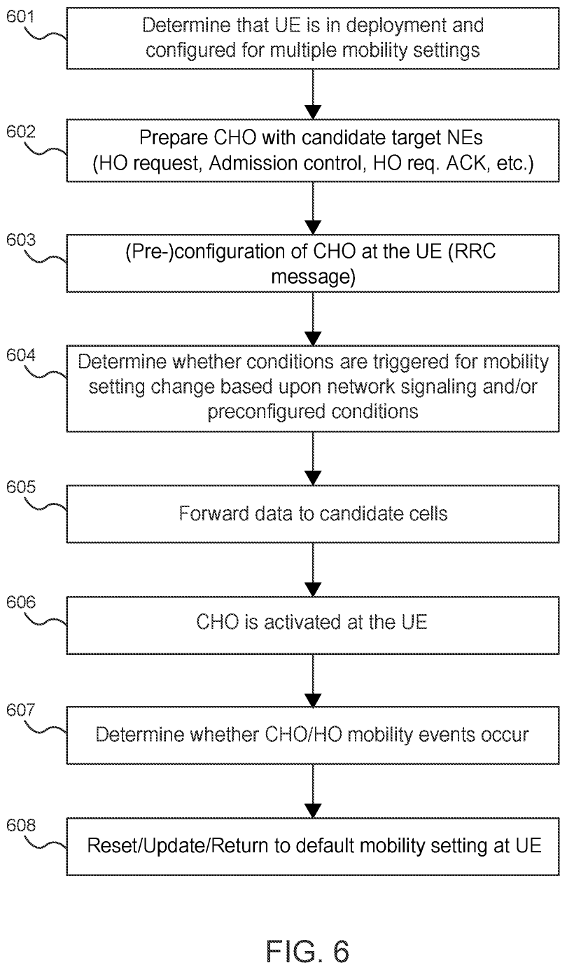

The HO may be reconfigured with aggressive cell mobility parameters. However, this may also affect other deployment areas that are distant from the cell edge, since such aggressive mobility parameters can cause unnecessary mobility events, and lead to unnecessary HOs and ping-pongs between cells, as shown in FIG. 5. In particular, FIG. 5 depicts system-level simulations comparing conservative and aggressive mobility settings, where settings that are more aggressive generally correspond with large increases in HO frequency. This may result in frequent interruptions and breaks in data transmissions, and a more general degradation in overall system performance.

CHO may lead to reduced HO procedure latencies, wherein the UE does not need an explicit HO command (e.g., based on a measurement report) from the base station to switch to the new cell. However, as explained above, configuring only one set of HO or CHO parameters may not always be optimal. In addition, CHO may trigger the UE to perform HO at unnecessary times (e.g., where the target cell is available long before the HO should occur).

Timely configuration of CHO (i.e., steps 2-3 in FIG. 1) may also increase RRC signaling delays from the base station and UE processing delays, creating additional latency in dynamic mobility conditions. Thus, it may be desirable for re-configuration of mobility parameters next to the area with special UE conditions (e.g., close to the edge of the beam/RRH coverage) to include UE reporting assistance without delaying the cell switch.

There may be scenarios where the lowest possible latency cell/beam switching delay is essential. In order to enable timely and robust HO, more aggressive HO parameters and/or reporting may be required in some areas, such as at the cell edge. However, closed mobility loops based on measurements may be too slow to avoid signal degradation from the serving beam. Generic mobility setting/configuration/parametrizations may also be unsuitable for all areas/UE conditions of the deployment/cell. If HO/CHO(s) with more aggressive parameters are configured too early, unnecessary mobility events may interrupt data transmissions, degrading network performance. Alternatively, timely configuration of CHO may also be difficult due to RRC signaling delays from the base station and UE processing delays.

Certain example embodiments described herein may have various benefits and/or advantages to overcome the disadvantages described above. For example, certain example embodiments may provide highly flexible mobility configurations tailored to the deployment due to the ability to configure multiple mobility settings in a cell. Slower mobility CHO setting preparation and preconfiguration operations may also be separated from the faster activation and execution steps. In addition, mobility settings may be activated with low latencies; thus, different mobility settings can be used in areas where they are specifically needed. For example, CHO with aggressive parameters may only be used in a small area near the edge of a RRH or cell. Furthermore, particular CHO mobility settings may be restricted to certain regions and/or UE conditions (e.g., when the last beam of the cell is used and/or when the UE can switch to the first beam of the new cell). As a result, mobility robustness may be improved with minimal performance losses. Thus, certain example embodiments discussed below are directed to improvements in computer-related technology.

Various example embodiments discussed herein may enable low latency switching and execution of different mobility settings in the cell, allowing the most appropriate mobility parameters to be used in the corresponding coverage areas/UE conditions. Several sets of CHO parameters (i.e., several different mobility settings) may be provided to the UE that is entering the cell (e.g., together with RRC configuration) or at a later stage (e.g., with RRC Reconfiguration). Compared to conventional CHO procedures, after the candidate target cells are prepared, and when the UE is configured with the CHOs (i.e., with new mobility settings), the UE may not be allowed to use CHOs before the mobility setting change is triggered. Thus, the UE may use its original mobility settings (e.g., regular HO or default CHO setting) in the wide area. At the same time, the most demanding and time-consuming preparation and signaling (e.g., steps 2 and 3 in FIG. 1) may be performed early enough, including before the UE enters the area where different (e.g., more aggressive) mobility settings shall be used. Then, the new mobility setting (i.e., another CHO setting) is triggered either with, for example, faster medium access control (MAC) control element (CE) or downlink control information (DCI) signaling, or alternatively, by certain conditions directly at the UE indicated to it at 603, as discussed below. Alternatively, other signaling may be used.

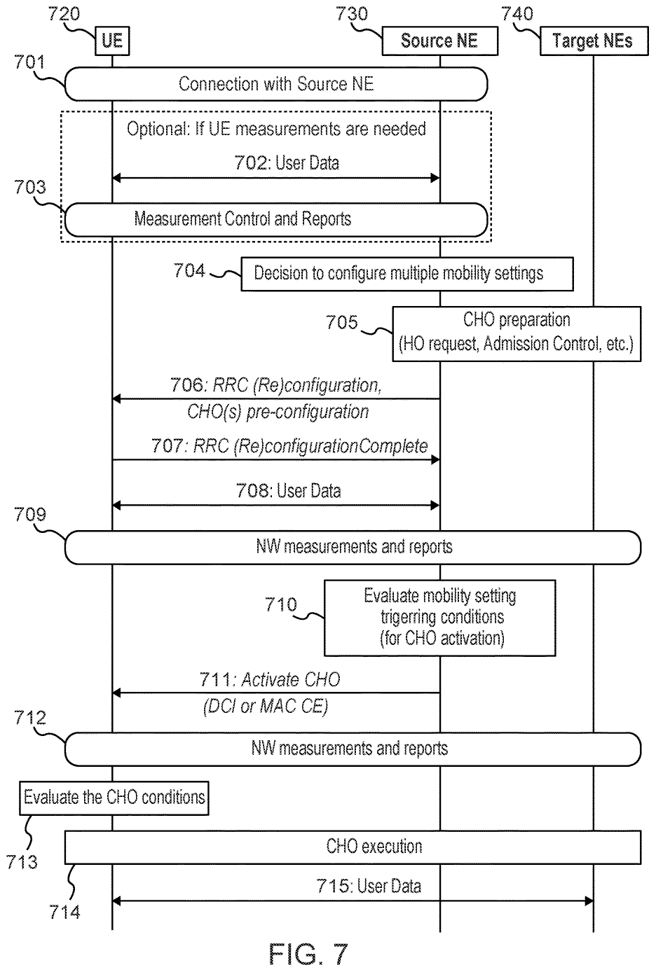

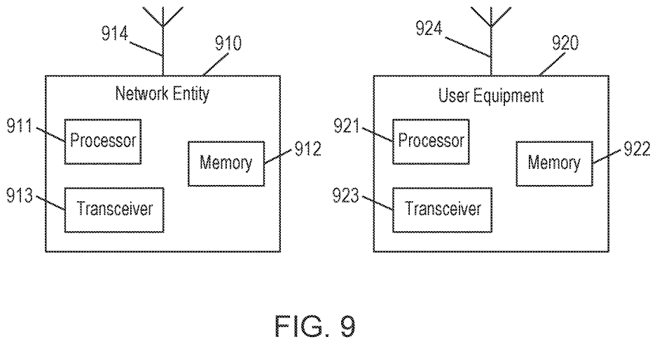

FIG. 6 illustrates an example of a flow diagram of a method of mobility setting preconfiguration, activation, and execution for the case of the non-limiting example using CHO that may be performed by a NE, such as NE 910 illustrated in FIG. 9, according to various example embodiments. More specifically, FIG. 5 depicts CHO (pre) configuration and activation as a realization of multiple mobility settings

At 601, the method may include determining whether the UE is deployed and/or whether conditions exist for multiple mobility settings.

At 602, the method may include preparing a CHO with at least one candidate NE, including parameters including HO request, admission control, and HO acknowledgement required.

At 603, the method may include either re-using existing RRC signaling or extending the existing RRC signaling with additional CHO activation and/or execution criteria where new mobility settings are (pre)configured (e.g., CHO configuration is signaled to the UE). For example, the new mobility settings may indicate that the CHO shall be activated only if a particular serving transmit (Tx) beam/transmission configuration indicator (TCI) state is used/activated. In some example embodiments, UE-based activation and switching to preconfigured CHO according to mobility settings may be triggered by CHO activation/switching conditions preconfigured at the UE by the NW, such as RRC signaling; this may be performed additionally to, or alternatively from, CHO pre-configured before 601.

Alternatively, the RRC signaling may indicate that the CHO is shall not be active before a mobility setting change is triggered (i.e., 604). In various example embodiments, the method may further include configuring the CHO with additional conditions that the CHO may be executed only for predefined target cells and/or beams. It is noted that 601-603 may be performed individually, in certain groups, or together (e.g., when the UE connects to a cell).

At 604, the method may include determining whether the conditions for the mobility change have been triggered. For example, if different mobility settings are to be applied only for a given serving beam/TCI state, and were already signaled to the UE at 603, the UE may activate a new mobility parameter setting (CHO setting) on its own. In various example embodiments, the new mobility parameter setting may be changed while executing CHO (e.g., serving cell is changed), or without executing CHO (e.g., serving cell is not changed). In some example embodiments, the change of mobility parameter setting may be executed while executing the CHO (e.g., change of the cell). In certain example embodiments, the change of mobility parameter setting may be executed without executing the CHO (e.g., the serving cell is not changed).

Alternatively, the decision to change mobility setting can be made at the NW side, and then signaled to the UE either explicitly or together with other signaling (e.g., with TCI state switching command). Alternatively, a NE may determine to change mobility setting, and then signal to the UE either explicitly or with other signaling (e.g., with TCI state switching command).

At 605, the method may include forwarding, by a source NE, data to candidate cells (i.e., early status transfer).

At 606, the method may include changing the mobility settings (i.e., CHO activation) at the UE, enabling the UE to execute CHO.

At 607, the method may include checking either regular or additional new conditions at 603 conditions for CHO execution. For example, new additional conditions may include that the target cell and/or beam are from the preconfigured list. The preconfigured conditions from 603 may also be checked.

At 608, the method may include resetting, updating, and/or returning to a default mobility setting at the UE.

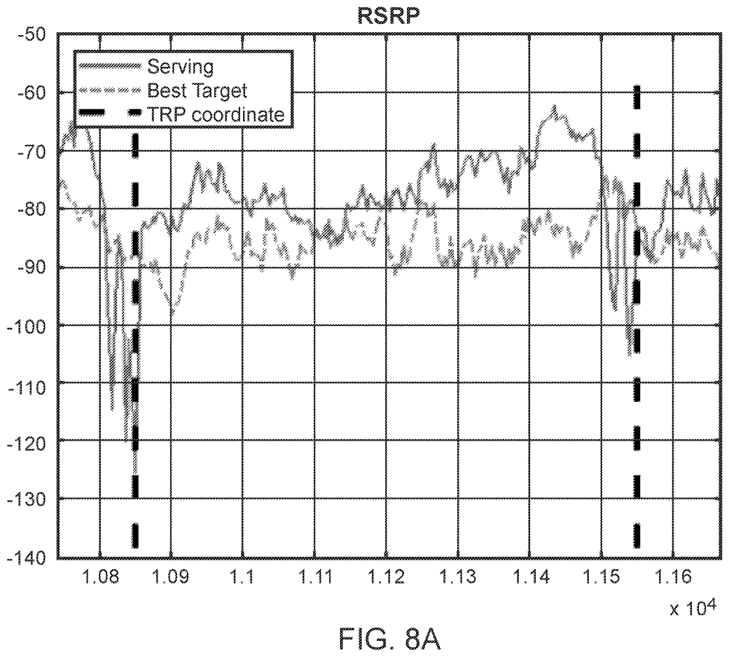

FIG. 7 illustrates an example of a signaling diagram depicting for mobility setting preconfiguration, activation, and execution for CHO. Source NE 730 and target NE(s) 740, and UE 720, may be similar to NE 910 and UE 920, respectively, as illustrated in FIG. 9, according to certain example embodiments.

At 701, UE 720 may establish a connection with source NE 730. Some default mobility settings may be used to establish the connection; for example, the default mobility settings may be regular HO-based mobility settings.

At 702, if source NE 730 already knows by some means at the connection establishment (e.g., from the sequence of the previous HOs, UE location) that multiple mobility settings (e.g., CHO configurations) need to be configured at UE 720, source NE 730 may provide those additional mobility settings to UE 720 at the initial RRC cell configuration. In various example embodiments, source NE 730 may use measurements to infer that UE 720 is moving and the direction of motion. At 703, NE 730 may transmit controls and/or measurement configurations and UE 720 may report measurements to source NE 730.

At 704, based on the measurement reports received from UE 720, source NE 730 may determine whether multiple mobility settings are needed.

At 705, target NE(s) 740 may prepare CHO with candidate cells.

At 706, if UE 720 has not received new mobility settings, source NE 730 may transmit a RRC message to UE 720, which may include at least one CHO preconfiguration. In various example embodiments, the RRC message may include new additional instructions for UE 720 regarding the CHO (i.e., preconfiguration and/or conditions to activate/change in between CHO configurations, i.e., mobility settings). For example, the RRC message may indicate to UE 720 that configured CHO may not be used before it is activated from source NE 730, or until an additional condition is triggered (e.g., UE 720 is switched to a particular TCI state/beam). In response, at 707, UE 720 may transmit to source NE 730 a RRC complete message.

At 708, UE 720 and source NE 730 may exchange user data.

At 709, UE 720, source NE 730, and target NE(s) 740 may perform NE measurements and reports.

At 710, source NE 730 may evaluate and detect at least one triggering condition, such as mobility setting triggering conditions for CHO preconfiguration activation. In particular, UE 720 may continue regular operation while source NE 730 continuously checks for CHO activation conditions (i.e., for conditions to trigger the change mobility settings). The mobility setting triggering conditions may be based upon network signaling or a preconfigured condition.

At 711, source NE 730 may transmit to UE 720, in response to the detection, an indication to activate the preconfigured CHO via DCI and/or MAC CE.

At 712, UE 720, source NE 730, and target NE(s) 740 may perform NE measurements and reports in normal operation. However, a new mobility setting (CHO configuration) may be active at UE 720.

At 713, UE 720 may continuously monitor for CHO conditions. For example, conditions may include regular CHO or additionally preconfigured conditions at 706 (e.g., target beam/TCI state).

At 714, UE 720, source NE 730, and target NE(s) 740 may execute, based upon the RRC message received at 706 and/or the indicated received at 711, the CHO, and data exchanges may continue with a new NE.

At 715, UE 720, source NE 730, and target NEs 740 may exchange user data.

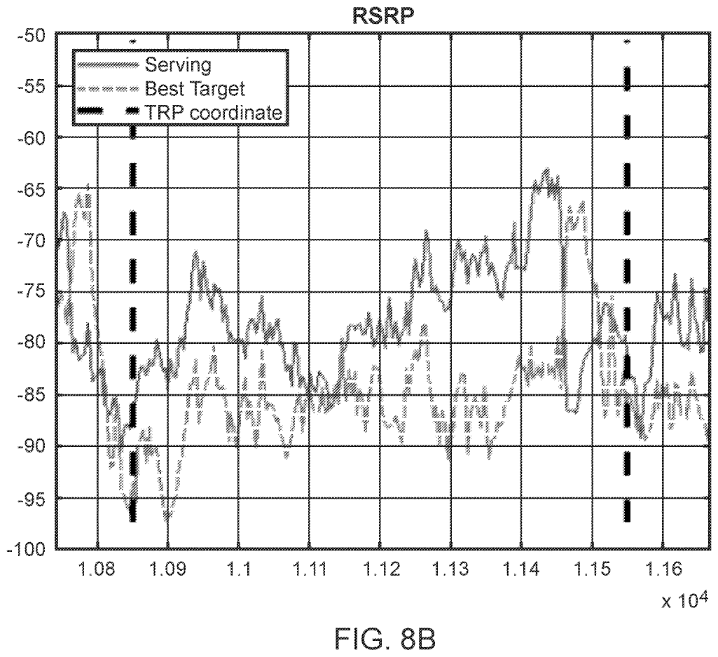

FIGS. 8A-B depict two RSRP time traces in an example where the train is traveling in the opposite direction to the serving beam, similar to that shown in FIG. 2. FIG. 8A depicts the RSRP trace when only one generic mobility setting is configured, while FIG. 8B illustrates a trace when two settings are use, with aggressive parameters next to the RRH. Both figures show that significant drops in the signal strength next to the RRH can be avoided.

FIG. 9 illustrates an example of a system according to certain example embodiments. In one example embodiment, a system may include multiple devices, such as, for example, NE 910 and/or UE 920.

NE 910 may be one or more of a base station, such as an eNB or gNB, a serving gateway, a server, and/or any other access node or combination thereof.

NE 910 may further comprise at least one gNB-centralized unit (CU), which may be associated with at least one gNB-distributed unit (DU). A gNB-CU and a gNB-DU may be in communication via at least one F1 interface, at least one Xₙ-C interface, and/or at least one NG interface via a 5^{th} generation core (5GC).

UE 920 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 910 and/or UE 920 may be one or more of a citizens broadband radio service device (CBSD).

NE 910 and/or UE 920 may include at least one processor, respectively indicated as 911 and 921. Processors 911 and 921 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 912 and 922. The memory may be fixed or removable. The memory may include computer program instructions or computer code contained therein. Memories 912 and 922 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 911 and 921, memories 912 and 922, and any subset thereof, may be configured to provide means corresponding to the various blocks of FIGS. 6-7. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 9, transceivers 913 and 923 may be provided, and one or more devices may also include at least one antenna, respectively illustrated as 914 and 924. The device may have many antennas, such as an array of antennas configured for multiple input multiple output (MIMO) communications, or multiple antennas for multiple RATs. Other configurations of these devices, for example, may be provided. Transceivers 913 and 923 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 6-7). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 6-7. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

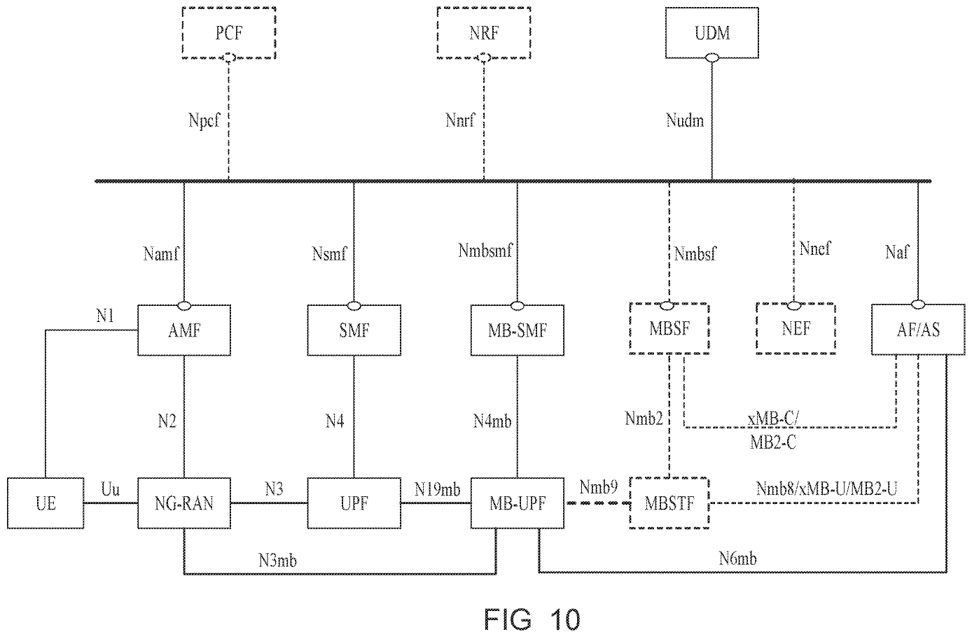

FIG. 10 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 10 may be similar to NE 1010 and UE 1020, respectively. The user plane function (UPF) may provide services such as intra-RAT and inter-RAT mobility, routing and forwarding of data packets, inspection of packets, user plane quality of service (QOS) processing, buffering of downlink packets, and/or triggering of downlink data notifications. The application function (AF) may primarily interface with the core network to facilitate application usage of traffic routing and interact with the policy framework.

According to certain example embodiments, processors 911 and 921, and memories 912 and 922, may be included in or may form a part of processing circuitry or control circuitry. In addition, in some example embodiments, transceivers 913 and 923 may be included in or may form a part of transceiving circuitry.

In some example embodiments, an apparatus (e.g., NE 910 and/or UE 920) may include means for performing a method, a process, or any of the variants discussed herein. Examples of the means may include one or more processors, memory, controllers, transmitters, receivers, and/or computer program code for causing the performance of the operations.

In various example embodiments, NE 910 may be controlled by memory 912 and processor 911 to transmit, to a user equipment, a control message comprising at least one preconfigured conditional handover; detect at least one setting associated with activation of at least one of the preconfigured conditional handovers; and transmit, to the user equipment, in response to the detection, an indication configured to activate conditional handover according to at least one of the preconfigured conditional handovers.

Certain example embodiments may be directed to an apparatus that includes means for performing any of the methods described herein including, for example, means for transmitting, to a user equipment, a control message comprising at least one preconfigured conditional handover; means for detecting at least one setting associated with activation of at least one of the preconfigured conditional handovers; and means for transmitting, to the user equipment, in response to the detection, an indication configured to activate conditional handover according to at least one of the preconfigured conditional handovers.

In various example embodiments, UE 920 may be controlled by memory 912 and processor 921 to receive, from a source network entity, a control message comprising at least one conditional handover preconfiguration; receive, from the source network entity, an indication configured to activate conditional handover according to the at least one conditional handover preconfiguration and at least one change triggering condition; and execute, based upon the received control message and received indication, conditional handover according to the at least one conditional handover preconfiguration.

Certain example embodiments may be directed to an apparatus that includes means for performing any of the methods described herein including, for example, means for receiving, from a source network entity, a control message comprising at least one conditional handover preconfiguration; means for receiving, from the source network entity, an indication configured to activate conditional handover according to the at least one conditional handover preconfiguration and at least one change triggering condition; and means for executing, based upon the received control message and received indication, conditional handover according to the at least one conditional handover preconfiguration.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP 3^{rd} Generation Partnership Project
5G 5^{th} Generation
5GC 5^{th} Generation Core
6G 6^{th} Generation
AF Application Function
AP Access Point
ASIC Application Specific Integrated Circuit
BS Base Station
CBSD Citizens Broadband Radio Service Device
CE Control Elements
CHO Conditional Handover
CN Core Network
CPU Central Processing Unit
CU Centralized Unit
dBm Decibel-milliwatts
DCI Downlink Control Information
DRX Discontinuous Reception
DU Distributed Unit
eMBB Enhanced Mobile Broadband
eNB Evolved Node B
FR Frequency Range
gNB Next Generation Node B
GPS Global Positioning System
HDD Hard Disk Drive
HO Handover
HST High-Speed Train
IoT Internet of Things
L1 Layer 1
L3 Layer 3
LTE Long-Term Evolution
LTE-A Long-Term Evolution Advanced
MAC Medium Access Control
MAC CE Medium Access Control Control Element
MEMS Micro Electrical Mechanical System
MIMO Multiple Input Multiple Output
mMTC Massive Machine Type Communication
mmWave Millimeter Wave
NE Network Entity
NG Next Generation
NG-eNB Next Generation Evolved Node B
NG-RAN Next Generation Radio Access Network
NR New Radio
PDA Personal Digital Assistance
QOS Quality of Service
RAM Random Access Memory
RAN Radio Access Network
RAT Radio Access Technology
RE Resource Element
RF Radio Frequency
ROM Read-Only Memory
RRC Radio Resource Control
RRH Remote Radio Head
RSRP Reference Signal Received Power
Rx Receive
SINR Signal to Interference & Noise Ratio
TCI Transmission Configuration Indicator
TRP Transmission Reception Point
Tx Transmit
UE User Equipment
UMTS Universal Mobile Telecommunications System
UPF User Plane Function
URLLC Ultra-Reliable and Low-Latency Communication
UTRAN Universal Mobile Telecommunications System
Terrestrial Radio Access Network

1-57. (canceled)

58. An apparatus comprising:
at least one processor; and
at least one memory storing instructions that, when executed by the at least one processor, cause the apparatus at least to:
receive, from a source network entity, a control message comprising at least one conditional handover preconfiguration;
receive an indication configured to activate conditional handover according to the at least one conditional handover preconfiguration and at least one change triggering condition; and
execute, based upon the received control message and received indication, conditional handover according to the at least one conditional handover preconfiguration.

59. The apparatus of claim 58, wherein the at least one change triggering condition comprises a network-indicated change.

60. The apparatus of claim 58, wherein the at least one change triggering condition comprises a UE-initiated trigger.

61. The apparatus of claim 58, wherein the control message comprises an indication that the at least one conditional handover preconfiguration is usable after it is activated by the source network entity.

62. The apparatus of claim 58, wherein the control message comprises an indication that the at least one conditional handover preconfiguration is usable after an additional condition is triggered.

63. The apparatus of claim 62, wherein the additional condition comprises the apparatus switching to at least one of the following: a particular transmission configuration indicator state or a particular transmission configuration indicator beam.

64. The apparatus of claim 62, wherein the additional condition comprises a signal condition.

65. The apparatus of claim 58, wherein the apparatus is configured with a plurality of mobility settings, and the at least one change triggering condition triggers change of mobility settings.

66. The apparatus of claim 58, wherein the indication to activate conditional handover is transmitted via at least one of the following: downlink control information or at least one medium access control control element.

67. The apparatus of claim 58, wherein the control message comprises at least one of the following: a radio resource control setup message, radio resource control configuration message, or a radio resource control reconfiguration message.

68. The apparatus of claim 58, wherein the apparatus comprises or is comprised in a user equipment.

69. An apparatus comprising:
at least one processor; and
at least one memory storing instructions that, when executed by the at least one processor, cause the apparatus at least to:
transmit, to a user equipment, a control message comprising at least one preconfigured conditional handover;
detect at least one change triggering condition associated with activation of at least one of the preconfigured conditional handovers; and
transmit, to the user equipment, in response to the detection, an indication configured to activate conditional handover according to at least one of the preconfigured conditional handovers.

70. The apparatus of claim 69, wherein the control message comprises an indication that at least one of the preconfigured conditional handovers is usable after it is activated by the apparatus.

71. The apparatus of claim 69, wherein the control message comprises an indication that at least one of the preconfigured conditional handovers is usable after an additional condition is triggered.

72. The apparatus of claim 71, wherein the additional condition comprises the user equipment switching to at least one of the following: a particular transmission configuration indicator state or a particular transmission configuration indicator beam.

73. The apparatus of claim 69, wherein the at least one memory and the instructions, when executed by the at least one processor, further cause the apparatus at least to:
continuously monitor for conditional handover.

74. The apparatus of claim 69, wherein the indication to activate the conditional handover according to at least one of the preconfigured conditional handovers is transmitted via at least one of the following: downlink control information or at least one medium access control control element.

75. The apparatus of claim 69, wherein the control message comprises at least one of the following: a radio resource control setup message, radio resource control configuration message, or a radio resource control reconfiguration message.

76. The apparatus of claim 69, wherein the at least one change triggering condition triggers change of mobility settings.

77. A method comprising:
receiving, from a source network entity, a control message comprising at least one conditional handover preconfiguration;
receiving an indication configured to activate conditional handover according to the at least one conditional handover preconfiguration and at least one change triggering condition; and
executing, based upon the received control message and received indication, conditional handover according to the at least one conditional handover preconfiguration.
